(19) United States
(12) Patent Application Publication
(10) Pub. No.: US 2009/0001986 A1
(43) Pub. Date: Jan. 1, 2009

(54) SYSTEMS AND METHODS FOR CALIBRATING AN ELECTROMAGNETIC RECEIVER

(75) Inventors: Christian Besson, Le Pecq (FR); Kamal Babour, BURES SUR YVETTE (FR); Kambiz A. Safinya, Houston, TX (US); Edward Nichols, Berkeley, CA (US)

Correspondence Address: WesternGeco L.L.C.;Jeffrey E. Griffin, 10001 Richmond Avenue, HOUSTON, TX, 77042-4299, US

(73) Assignee: SCHLUMBERGER TECHNOLOGY CORPORATION, Sugar Land, TX (US)

(21) Appl. No.: 11/771,598

(22) Filed: Jun. 29, 2007

(51) Int. Cl. G01V 3/08

(52) U.S. Cl. 324/335; 324/334

(57) ABSTRACT

An electromagnetic receiver includes at least one sensor for measuring electromagnetic signals, and a calibration antenna configured to generate an electromagnetic signal at a first frequency.

### FIELD OF THE INVENTION

The present invention relates to systems and methods for calibrating electromagnetic receivers for use in geophysical surveys.

### BACKGROUND OF THE INVENTION

The exploration of hydrocarbons, such as oil and gas, is usually performed in the form of geological survey. The survey is done during the reservoir assessment and development stage to avoid unnecessary drilling. Hydrocarbons and geological structures that tend to bear hydrocarbons can be detected based on the fact that their mechanical and electromagnetic (EM) properties are different from those of a background geological formation.

Among the EM properties, the resistivity (ρ), which is an inverse of the electrical conductivity (σ), is particularly useful. This is because hydrocarbon-bearing bodies, such as oil-bearing reservoirs, gas injection zones, and methane hydrates, may have different resistivities as compared with a background geological formation. For example, hydrocarbon-bearing reservoirs typically have a resistivity that is one to two orders of magnitude higher than the surrounding shale and water-bearing zones. A resistivity mapping or imaging can be used to locate the zones of interest in contrast to the background resistivity. This method has been used successfully in land or sea bed logging.

The resistivity mapping can be achieved by receiving EM signals that have traveled through the geological structures. The received data in EM logging are affected by a number of parameters, for example, the distance between the EM signal source and the receivers, EM field frequency, polarity of the EM waves, depth and thickness of the reservoir, and other factors (e.g., resistivity of sea water and surrounding geological formations).

The EM signals used in such surveys may be naturally occurring or may come from artificial sources. Among the various EM survey methods, magneto-telluric (MT) method takes advantage of naturally-occurring EM fields in geological formations. Because carbonates, volcanics, and salt all have large electrical resistivity in contrast with typical sedimentary rocks, MT measurements can produce high-contrast images of resistivity maps, and are particularly useful in examining large-scale basin features and for characterizing reservoirs below basalt (volcanics) layers beneath the sea bed.

Most recent EM methods use artificial EM sources that produce time-varying EM fields. The EM fields may include an EM pulse generated by turning on and off the EM transmitter. In this case, the receivers effectively measure a pulse response of the geological structures. The EM fields may be in the form of low-frequency EM waves with a fixed frequency, or with a combination of different frequencies.

Another EM survey method, referred to as the controlled source electromagnetic (CSEM) method, uses an artificial EM source to send controlled EM fields to a geological formation. As illustrated in FIG. 1, in a conventional CSEM method, an electrical dipole transmitter 11 is towed by a ship 10 at a short distance above the seabed 12. The transmitter 11 induces EM fields throughout the sea water 14, geological layers 15 and 16, as well as in the oil-bearing layer 17. A number of receivers 13 are deployed on the seabed 12 to measure the EM signals.

FIG. 2 shows a conventional receiver when deployed on sea floor. As shown, the receiver 20 has a central frame 25, from which pairs of electrodes (e.g., 21a, 21b) are extended by extension arms (e.g., 22a, 22b) for measuring voltage drop across the distance between the pair of electrodes. In this example, the electrode pair 21a, 21b measures the electrical field component in the horizontal direction. A receiver may also include another pair of electrodes in the horizontal plane that are orthogonal to the pair 21, 21b shown in FIG. 2. The second horizontal pair is not shown in FIG. 2, but they would be into and out of the page. Another electrode pair 21c, 21d measures the electrical field component in the vertical direction. In other examples, a receiver may include magnetometers that measure the magnetic field in one, two, or three directions. Thus, a receiver may measure the electric and magnetic fields in three orthogonal directions.

Ideally, the receivers, which may comprise electrodes and/or antennas, should be able to measure various components of the EM fields. That is, each of the receivers should correctly measure one component of the EM fields, including electrical field (Ex, Ey, Ez) and magnetic field (Bx, By, Bz). However, this is not always the case due to various reasons. For example, the orientation of the receivers may have changed during deployment at the sea bottom, in a borehole, or at the earth surface, such that the receivers no longer measure exactly orthogonal components. For example, the electrode pair 21a, 21b may be tilted or bent on the seafloor. Similarly, the vertical arm 22c may move with the current of the sea water.

Typically, the signals measured by the receivers are a linear function of the field: S=a F+h, wherein a is a gain and b is an offset. However, the relationship may be a complex function, with a real and an imaginary parts, when both the amplitude and the phase of the signals are measured. In any event, the gain a and offset b of a receiver are typically determined in the laboratory prior to deployment. However, the gain and offset can change with time or environmental factors (such as pressure or temperature), or they may change during handling and deployment of the equipment. Thus, the pre-deployment calibration maybe insufficient to ensure that a receiver will function as intended.

In addition, certain receivers may have unique problems that cannot be anticipated or resolved with pre-deployment calibration. An example of this situation can be found in an electric field receiver of the type described in French Patent No. 84 19577 issued to Jean Mosnier and PCT Patent Publication No. WO 2006/026361 A1 by Steven Constable (one example is shown in FIG. 3). With such receivers, which measure current densities flowing through a pair of electrodes, the measurement may be affected by the contact impedance between the current electrodes and the sea-water electrolyte outside the receiver. This contact impedance is generally complex, with a capacitive part that cannot be fully compensated over a large frequency range. As a result, the measured phase may be shifted from the phase of the original electric field. Again, such problems cannot be resolved with calibration in the laboratory.

Therefore, there exists a need for methods that can be used to calibrate the responses of EM receivers in-situ, to determine the correction factors or parameters for the gains and offsets, to verify the proper functioning of the receivers after they have been deployed, or to provide correction factors in data analysis.

### SUMMARY OF INVENTION

In one aspect, an electromagnetic receiver includes at least one sensor for measuring electromagnetic signals, and a calibration antenna configured to generate an electromagnetic signal at a first frequency.

In another aspect, a method for calibrating an electromagnetic receiver includes energizing a calibration antenna disposed within the receiver to generate an electromagnetic signal, and detecting the electromagnetic signal using at least one sensor disposed within the receiver.

In another aspect, a method for making an electromagnetic survey includes deploying a plurality of electromagnetic receivers on a seafloor, and for each receiver, energizing a calibration antenna in receiver to generate a calibration electromagnetic signal and detecting the calibration electromagnetic signal using one or more sensors in the receiver. The method also includes generating a controlled source electromagnetic signal external from the receiver, detecting the controlled source electromagnetic signal with one or more of the receivers, and for each receiver, correcting the detected controlled source electromagnetic signal using the detected calibration electromagnetic signal.

Other aspects and advantages of the invention will be apparent from the following description and the appended claims.

### BRIEF DESCRIPTION OF DRAWINGS

FIG. 1 shows an example of a conventional controlled source electromagnetic measurement system.

FIG. 2 shows an example of a conventional receiver including four electrodes for measuring electric fields by measuring voltage drops across opposing electrode pairs.

FIG. 3 shows an example of a conventional receiver having a cubic frame for measuring an electric field by measuring electric current densities.

FIG. 4 illustrates an example situation that can change the characteristics of a receiver after deployment.

FIG. 5 shows an example receiver having a calibration unit.

FIG. 6 shows flow chart illustrating an example method for calibrating a receiver.

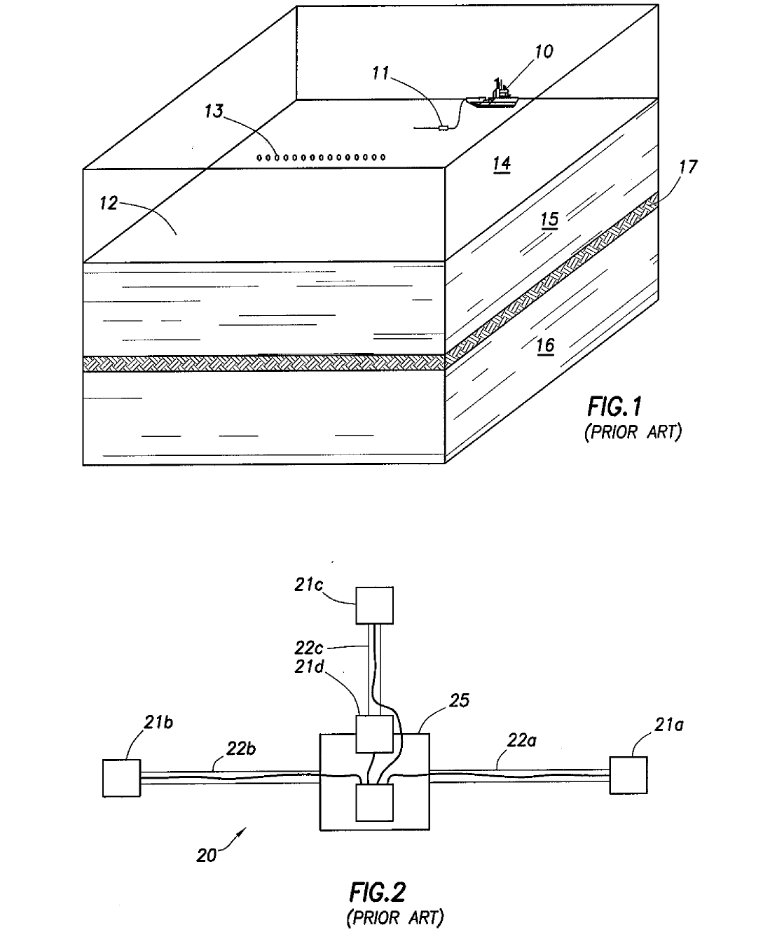

### DETAILED DESCRIPTION

Embodiments of the present invention relate to methods for calibrating electromagnetic receivers. In accordance with embodiments of the invention, a electromagnetic source for providing a known electric and/or magnetic field for calibrating the sensors in a receiver may be included in a sub sea receiver A sensor in a receiver may be an electrode, an antenna, a magnetometer, or a combination thereof.

In accordance with one or more disclosed examples, a receiver may include a calibration antenna or electrode capable of generating an EM field when powered by a suitable power source. The generated EM field is of a known strength such that it can be used to calibrate the sensors in the receiver in the measurement device. Thus, at chosen times, e.g., after deployment of the device, before or after each survey data acquisition, at preset time intervals, or at appropriate times during a subsea survey, the calibration antenna or electrode may be energized, creating a known EM field in the vicinity of the device. The signals induced in the sensors in the receiver are recorded and compared to the expected responses of the sensors to the known EM field. This comparison can be used to determine calibration parameters (such as offsets, gains, misalignments, or other parameters describing the responses of the receivers), which may be used to calibrate the sensors before measurements or used to correct the measurements acquired by the receivers during the processing of the survey data. These corrections and/or calibrations may be applied locally, using the on-board processor or control unit built into the device. Alternatively, the data may be corrected in the processing phase, where the data from all of the receivers analyzed.

A calibration unit may be applied to various types of EM receivers, including a receiver disclosed by Jean Mosnier and Steven Constable noted above. FIG. 3 shows one such receiver, which includes electrodes disposed on sides of a cubic frame. As shown, a measurement/receiver device 30 includes electrodes 31 and 32 disposed on opposite sides of the cubic frame. The electrodes are connected via a circuitry 33 having an impedance Z, which ideally should be tuned such that the impedance of the receiver is identical to that of the seawater 34. If the impedance between the electrodes 31 and 32 are tuned to that of the seawater, then the presence of the receiver in the seawater will not perturb the electric field of the measurement site. Therefore, the current I that passes through electrodes 31 and 32 will have the original density.

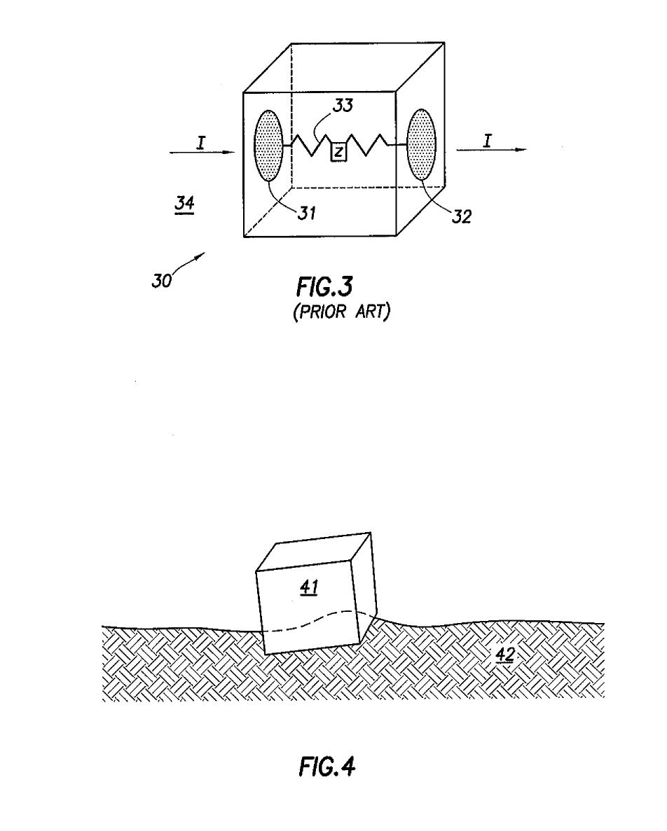

In some cases, it may be desirable to tune the receiver impedance Z to that of the surrounding seawater, however, this often is impractical because the seawater resistance may not be known beforehand. Furthermore, the resistance (or conductivity) of seawater can vary with time, temperature, salt concentration, etc. In addition, the process of deploying such a receiver to the sea floor may cause an otherwise perfectly tuned receiver to become imperfect. For example, the receiver, when deployed on a weak sea floor, may sink into the sea floor, as illustrated in FIG. 4. As a result, the receiver/measurement device will have a part buried in sea floor 42 and a part 41 exposed to sea water. These two parts of the receiver device will likely experience different electromagnetic characteristics. Therefore, an originally perfect receivers will become imperfect.

For the above and other reasons, it may be impractical to rely on pre-deployment calibration to ensure that the receivers will behave as intended after deployment. The disclosed examples, instead, rely on in-situ calibration to ensure that the receivers are properly calibrated under the measurement conditions. Alternatively, embodiments of the invention can provide calibration parameters (factors) that can be applied to the measured signals to correct for errors that arise from receiver imperfection under the measurement conditions.

In accordance with some examples, a receiver may include a calibration unit. FIG. 5 shows one such receiver 50, in which a calibration unit 55 is included in a receiver having two electrodes 31 and 32 connected by a circuitry having an impedance Z, as shown in FIG. 3. The calibration unit 55 includes an electric dipole antenna 52 and a power source 54. The power source 54 can be energized at selected time to cause the antenna 52 to induce an EM field 56, which is detected by the electrodes 31 and 32 in the receiver unit. In some embodiments, the calibration unit may not include a power unit. Instead, the calibration antenna is powered by a source from outside (e.g., a cable connected to the measurement device). The signals thus detected by electrodes 31 and 32, in response to the calibration EM field 56, may be used to calibrate the electrodes via a control or processor 57. Alternatively, the signals recorded by the electrodes 31 and 32 may be stored in memory to provide correction factors that may be applied to the measurement data. In one example, a correction factor may be applied to the data during the inversion process to analyze the data from all of the receivers used in a subsea survey.

For example, with the type of receiver shown in FIG. 3, it is known that the impedance between the electrodes and the sea water is very difficult to predict in advance. Consequently, laboratory calibration performed prior to deployment is typically incapable of fine tuning the receiver impedance to match that of the sea water. By including a calibration antenna in a receiver in accordance with embodiments of the invention, it becomes possible to calibrate such receivers in situ to match the impedance between the electrodes and the seawater.

Further, in some applications, a receiver may be intentionally set to lower impedance relative to the impedance of the sea water in order to allow more current to flow through the electrodes. This has the effect if increasing the detection sensitivity of the receiver. Such receivers are disclosed in a co-pending application Ser. No. 11/770,902 by Besson, et al., entitled “Methods for Electromagnetic Measurements and Correction of Non-Ideal Receiver Responses,” filed on Jun. 29, 2007 (attorney docket No. 115.0017). The imperfection in impedance match in this case can be corrected during data analysis based on the calibration responses recorded by the receiver when the calibration antenna is energized.

In some examples, the strength of the calibration unit (e.g., 54 in FIG. 5) may be adjusted so that the current (density?) entering the receiver electrodes during calibration is similar to that expected during actual surveys. This may avoid any uncontrolled dependence of the contact impedance on current density.

One skilled in the art would appreciate that the emitting antenna (e.g., 52 in FIG. 5) in the calibration unit can be a magnetic source (such as a torroid), an electric dipole, or combinations of the above. Any type of antenna can be used, as long as the electric and magnetic fields generated by the antenna in the vicinity of a receiver can be determined or pre-computed using methods known in the art.

The calibration antenna can be powered by batteries built into the receiver. Alternatively, the calibration antenna may be energized by power transferred through a cable from an external power source, such as in the case where the receivers are linked by cable. In a typical sea-bottom CSEM survey, the receivers are not typically tethered, and the emitting antenna may be powered by batteries. This may limit the amount of energy that can be used in the calibration antennas, and therefore the strength of the EM fields used for calibration. However, this is usually not a problem, because the calibration antennas are located close to the sensors in the receivers.

In some EM surveys, the measurements are performed with a variety of frequencies to take advantage of the frequency-dependent responses. For example, it is known that lower frequency EM signals can traverse deeper into the formations (i.e., large skin depth), while the higher frequency EM signals produce better signal-to-noise ratios. In accordance with some embodiments of the invention, the calibration antennas may be powered at a range of different frequencies in order to calibrate the receivers over a range of frequencies. A range of frequencies can be achieved by a variety of means known in the art, including sequential excitation at different frequencies, frequency sweeps, frequency chirps, time domain excitation, etc.

While the above example uses a receiver as shown in FIG. 3 to illustrate embodiments of the invention, one skilled in the art would appreciate that embodiments of the invention may be applied to other types of receivers. For example, embodiments of the invention may be applied to the conventional receivers presently in use in marine surveys, such as those used by EMGS, Schlumberger, and OHM.

Furthermore, embodiments of the invention are not limited to determining the contact impedance and making adjustments. In addition to the calibration of receiver impedance described above, such calibrations may also allow correction for any changes due to temperature, pressure, and/or due to vector infidelity, such as caused by electrode arms being non-orthogonal when they come to rest on the sea floor. In addition, the use of the local calibration may also allow numeric tracking the vertical electrodes (e.g., 21c in FIG. 2) if they are moving in response to currents, or non-vertical due to a tilted sea bottom.

In addition, calibration methods may use a wide range of frequencies (or short time constants for time domain source waveforms) of the calibration signals to enable the measurement of local perturbations to the main electric field caused by the local environment around the receiver. Such local perturbations may include, for example, resistive bottom or nearby ridge or fracture which will cause a local static distortion of the measured EM fields. Because the depths, orientations, and locations of such local perturbations relative to the receivers are not known before deployment of the receivers, they cannot be calibrated beforehand. Having the ability to transmit calibration signals at different frequencies, it becomes possible to either map such local perturbations or to collect parameters at different frequencies for data correction in the inversion process.

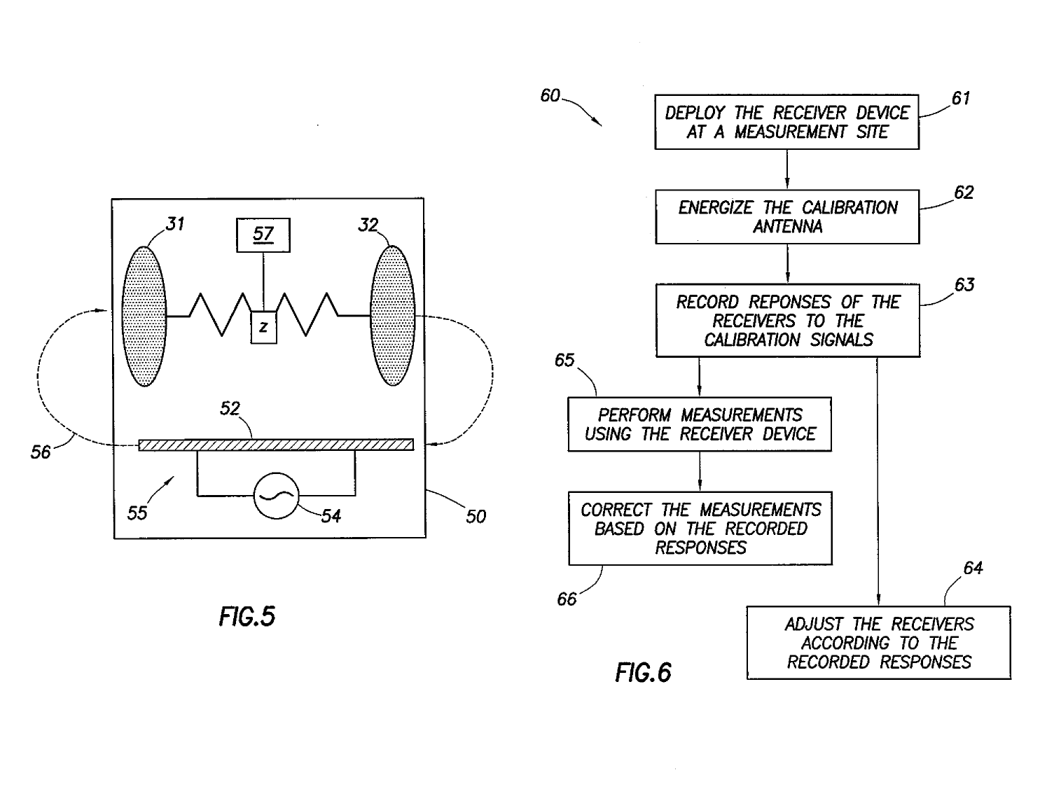

FIG. 6 shows a flow chart illustrating a method 60 in accordance with one embodiment of the invention. First, receivers may be deployed at a measurement site (step 61). In one example, this is accomplished by dropping the receivers from a boat and allowing them to descend to the seafloor. In a further example, receivers may be positioned using an ROV on the seafloor. A receiver may include a calibration unit, which may include a calibration antenna and a power source. The calibration antenna is then energized to generate calibration signals (step 62). The antenna may be energized at a single frequency, at several discrete frequencies, or it may be energized to sweep through a range of frequencies. In one example, an antenna may be energized at several harmonic frequencies, such as 0.25, 0.75, 1.25, and 1.75 Hz. In another example, the antenna may be energized at 0.612, 0.1875, 0.325 Hz. In another example, the antenna may be energized to sweep over the frequency range from 0.06 to 10 Hz.

The calibration signals are detected and recorded by the sensors in the receiver (step 63). The recorded responses may be used to adjust the receivers before measurements (step 64). In one example, the adjustment may be to match the impedance to that of the surrounding environment. In another example, the impedance may be intentionally mismatched to focus the current. In yet another example, a receiver may be repositioned by an ROV based on the calibration data. Alternatively, the receiver may perform the measurements without first fine-tuning the receivers (step 65), and then the recorded responses of the receiver to the calibration signals may be used to correct for receiver imperfections in the measurement data (step 66). Note that in the alternative approach, the measurements may be performed before or after the receiver calibration is performed.

Note that the method shown in FIG. 6 is for illustration only and one skilled in the art would appreciate that other modifications of this method are possible without departing from the scope of the claims. For example, the activation of the calibration EM source and the calibration of the receiver may be performed right after the deployment of the receiver, or before or after each survey data acquisition. The receivers can also be calibrated periodically at predetermined time intervals by setting the time to activate the calibration EM source. In another example, the receiver may be calibrated at several times during a subsea survey, for example, at a time when the controlled source is distant from the receiver.

Advantages may include one or more of the following. A receiver for EM measurements in accordance with disclosed examples may include a calibration unit. Such receivers are capable of performing in-situ calibration. The calibration results may be used to fine tune the receivers before the measurements are made. Alternatively, the calibration results may be used on measurement data that have been acquired.

Being able to perform in-situ calibration makes it possible to ensure that a receiver is properly calibrated at the measurement site before the measurements are made. Furthermore, many factors that impact the characteristics of a receiver cannot be ascertained beforehand. In this case, in-situ calibration offers the real alternative to ensure that the receivers are properly calibrated before the measurements are made.

Some disclosed examples of the invention use a range of frequencies to perform the receiver calibrations. In this case, the multiple frequencies allows the user to identify and/or correct for local perturbations at the measurement sites. Such local perturbations may include fractures, layers of unusual resistivities, dipping formations, etc.

While the invention has been described with respect to a limited number of embodiments, those skilled in the art, having benefit of this disclosure, will appreciate that other embodiments can be devised which do not depart from the scope of the invention as disclosed herein. For example, although the exemplary embodiments of the present invention have been described in terms of receivers used in sea bed logging, one of ordinary skill in the art would appreciate that the receivers and methods of the present invention may also be applied to other types of measurements such as MT measurements and inland subsurface surveys. Accordingly, the scope of the invention should be limited only by the attached claims.

1. An electromagnetic receiver, comprising:
at least one sensor for measuring electromagnetic signals; and
a calibration antenna configured to generate an electromagnetic signal at a first frequency.

2. (canceled)

3. (canceled)

4. The receiver of claim 1, further comprising a power source coupled to the calibration antenna.

5. (canceled)

6. The system of claim 1, wherein the calibration antenna is an electric dipole.

7. The receiver of claim 1, wherein the calibration antenna is a magnetic dipole.

8. The system of claim 1, wherein the calibration antenna is configured to generate an electromagnetic field at a second frequency.

9. The method of claim 8, wherein the first frequency is about 0.06 Hz and the second frequency is about 10 Hz.

10. The system of claim 8, wherein the calibration antenna is configured to generate the electromagnetic field that sweeps from the first frequency to the second frequency.

11. The system of claim 1, wherein the receiver comprises a pair of electrodes separated by a selected distance and connected via a circuitry for measuring a current flowing through the pair of electrodes.

12. The system of claim 11, wherein the circuitry connecting the pair of electrodes comprises a control for adjusting an impedance between the pair of electrodes.

13. The system of claim 1, further comprising a memory for recording signals measured by the at least one sensor.

14. The receiver of claim 1, wherein the at least one sensor comprises at least one of 1) a pair of electrodes; 2) three pairs of electrodes arranged in mutually orthogonal directions; 3) a magnetometer and 4) three magnetometers.

15. (canceled)

16. (canceled)

17. (canceled)

18. A method for calibrating an electromagnetic receiver, comprising:
energizing a calibration antenna disposed within the receiver to generate an electromagnetic signal; and
detecting the electromagnetic signal using at least one sensor disposed within the receiver.

19. The method of claim 18, further comprising deploying the receiver to a seafloor position.

20. (canceled)

21. The method of claim 18, further comprising storing data collected by the at least one sensor when detecting the electromagnetic signal.

22. The method of claim 21, further comprising:
collecting survey data using the at least one sensor, and
analyzing the calibration data collected by the at least one sensor to correct the survey data.

23. The method of claim 18, further comprising adjusting at least one parameter of the receiver based on the detected data.

24. The method of claim 23, wherein the parameter comprises at least one of 1) at least one selected from an impedance between at least one pair of electrodes, a position of the receiver, and an orientation of the receiver; 2) the impedance between at least one pair of electrodes, and wherein the impedance is adjusted to match that of surrounding seawater; 3) the impedance between at least one pair of electrodes and wherein the impedance is adjusted to be below that that of surrounding seawater; and 4) the position of the receiver, and wherein adjusting the position of the receiver comprises using an ROV to reposition the receiver.

25. (canceled)

26. (canceled)

27. (canceled)

28. The method of claim 18, further comprising determining the electromagnetic field generated by energizing the calibration antenna; wherein determining the electromagnetic field comprises pre-computing the electromagnetic field.

29. (canceled)

30. (canceled)

31. (canceled)

32. The method of claim 18, wherein the at least one sensor comprise a vertical electric field sensor, and further comprising using the detected electromagnetic field to adjust for movement of the vertical electric field sensor.

33. A method for making an electromagnetic survey, comprising:
deploying a plurality of electromagnetic receivers on a seafloor;
for each receiver:
energizing a calibration antenna in receiver to generate a calibration electromagnetic signal; and
detecting the calibration electromagnetic signal using one or more sensors in the receiver,
generating a controlled source electromagnetic signal external from the receiver;
detecting the controlled source electromagnetic signal with one or more of the receivers; and
for each receiver, correcting the detected controlled source electromagnetic signal using the detected calibration electromagnetic signal.

34. The method of claim 33, wherein energizing the calibration antenna is done at a plurality of frequencies.

35. The method of claim 33, wherein the generating the controlled source electromagnetic signal is done at a plurality of frequencies.

36. The method of claim 33, further comprising, adjusting a parameter for at least one receiver based on the detected calibration electromagnetic signal.

37. (canceled)
